(19) United States
(12) Patent Application Publication
(10) Pub. No.: US 2026/0259813 A1
(43) Pub. Date: Sep. 3, 2026

(54) TECHNOLOGIES FOR EFFICIENTLY VALIDATING DATA ELEMENTS FOR PROGRAM COMPLIANCE

(71) Applicant: Vespa Group, LLC, Indianapolis, IN (US)

(72) Inventor: Anthony J. Vespa, Carmel, IN (US)

(21) Appl. No.: 19/066,423

(22) Filed: Feb. 28, 2025

(51) Int. Cl. G06F 11/34; G06F 9/451

(52) U.S. Cl. CPC G06F 11/3447; G06F 9/451

(57) ABSTRACT

Technologies for data modeling include a computing device in communication with multiple client devices. The computing device updates a data model based on a data element definition and a rule definition. The data model includes multiple data elements, data validation rules, and scopes. Each scope may be associated with a program, and each data element may be associated with a program participant. The computing device may update executable rule logic based on a description in the rule definition. The computing device generates a user interface for a scope of the data model and the data elements associated with the scope. The computing device receives an input value in response to presenting the user interface, selects a data validation rule based on an associated data element, and executes the data validation rule. The computing device may provide an indication of any validation error. Other embodiments are described and claimed.

### BACKGROUND

Many organizations have detailed requirements for record keeping and reporting in order to ensure compliance or otherwise participate in programs. For example, the U.S. Department of Labor (DOL) administers various programs under the Workforce Innovation and Opportunity Act (WIOA). Under this act, states and other grantees are required to report certain detailed performance data. This reporting requirement has been implemented using a Participant Individual Record Layout (PIRL) provided by the DOL (or other entity). Typically, reports may be prepared manually or batch-processed using custom reporting software, which is labor intensive and may require long lead times. Additionally, even software-generated reports may include errors that result in a report being rejected by the administrator, which may cause delays in reporting. Further, the PIRL, reporting requirements, validation rules, or other requirements may be changed by the DOL from time to time. Typically, reporting systems are modified manually based on changed requirements, which is labor intensive and may have extremely long lead times.

### SUMMARY

According to one aspect of the disclosure, a computing device for real-time data model interaction includes a data model comprising a plurality of data elements and a plurality of scopes and a data element definition manager. Each data element includes a data element identifier, a data element type, and a data element format. Each data element is associated with one or more scopes of the data model. The data element definition manager is to update a data element of the data model based on a data element definition indicative of a data element identifier, a data element type, a data element format, and one or more scopes. In some embodiments, each of the scopes is associated with a program, and each data element is associated with a program participant.

In some embodiments, the data element definition includes structured or unstructured data indicative of the data element identifier, the data element type, the data element format, and the one or more scopes. In some embodiments, to update the data element includes to parse the data element definition. In some embodiments, the data element definition further includes a natural language description of the data element. In some embodiments, to update the data element includes to process the data element definition with a large language model.

In some embodiments, the computing device further includes a rule definition manager. The data model further includes a plurality of data validation rules. Each data validation rule includes an executable rule logic, and each data validation rule is associated with one or more data elements of the data model and one or more scopes of the data model. The rule definition manager is to update a data validation rule of the data model based on a rule definition indicative of one or more data elements of the data model, rule logic, and one or more scopes of the data model. The executable rule logic of the data validation rule corresponds to the rule logic of the rule definition. In some embodiments, the executable rule logic includes an input validation rule that determines whether a data element type or data element format is valid for the corresponding one or more data elements of the data model. In some embodiments, the executable rule logic includes a mandatory value rule that determines whether a data element value is stored for the corresponding one or more data elements of the data model. In some embodiments, the executable rule logic includes a Boolean function of the one or more data elements.

In some embodiments, the rule definition includes structured or unstructured data indicative of the one or more data elements, the rule logic, and the one or more scopes. In some embodiments, to update the data validation rule includes to parse the rule definition. In some embodiments, the rule definition further includes a natural language description of the rule logic. In some embodiments, to update the data validation rule includes to process the rule definition with a large language model.

In some embodiments, the computing device further includes an interface generator to generate a user interface for a scope of the data model and the one or more data elements of the data model associated with the scope. The user interface includes a plurality of user interface controls. The user interface is associated with the scope of the data model, and each user interface control of the user interface is associated with a data element of the data model. In some embodiments, the rule definition is indicative of an external document, and to generate the user interface includes to generate a link to the external document.

In some embodiments, the computing device further includes an interface controller to present a first user interface associated with a first scope to a user; receive a first input value for a first data element of the data model in response to presentation of the first user interface to the user; select a first data validation rule of the data model based on the first data element and the first scope; execute an executable rule logic of the first data validation rule with the first input value in response to selection of the first data validation rule; and determine whether the executable rule logic successfully validated the input value in response to execution of the executable rule logic. In some embodiments, the interface controller is further to store the first input value for the first data element of the data model in response to a determination that the executable rule logic successfully validated the first input value. In some embodiments, the interface controller is further to provide an indication of a validation error in response to a determination that the executable rule logic did not successfully validate the first input value. In some embodiments, to provide the indication of the validation error includes to provide a link to a user interface associated with a data element of the data model related to the validation error.

In some embodiments, the computing device further includes a report generator to generate a report based on a report definition indicative of a scope of the data model and one or more data elements of the data model associated with the scope. To generate the report includes to retrieve data element values for the one or more data elements of the data model.

According to another aspect, a method for real-time data model interaction includes receiving a data element definition indicative of a data element identifier, a data element type, a data element format, and one or more scopes; and updating, by a computing device, a data element of a data model based on the data element definition, wherein the data element comprises the data element identifier, the data element type, the data element format, and wherein the data element is associated with the one or more scopes of the data model. In some embodiments, each of the scopes is associated with a program, and wherein the data element is associated with a program participant.

In some embodiments, the data element definition includes structured or unstructured data indicative of the data element identifier, the data element type, the data element format, and the one or more scopes. In some embodiments, updating the data element includes parsing the data element definition. In some embodiments, the data element definition further includes a natural language description of the data element. In some embodiments, updating the data element includes processing the data element definition with a large language model.

In some embodiments, the method further includes receiving a rule definition indicative of one or more data elements of the data model, rule logic, and one or more scopes of the data model; and updating, by the computing device, a data validation rule of the data model based on the rule definition, wherein the data validation rule includes an executable rule logic corresponding to the rule logic of the rule definition, and wherein the data validation rule is associated with the one or more data elements of the data model and the one or more scopes of the data model. In some embodiments, the executable rule logic includes an input validation rule that determines whether a data element type or data element format is valid for the corresponding one or more data elements of the data model. In some embodiments, the executable rule logic includes a mandatory value rule that determines whether a data element value is stored for the corresponding one or more data elements of the data model. In some embodiments, the executable rule logic includes a Boolean function of the one or more data elements.

In some embodiments, the rule definition includes structured or unstructured data indicative of the one or more data elements, the rule logic, and the one or more scopes. In some embodiments, updating the data validation rule includes parsing the rule definition. In some embodiments, the rule definition further includes In some embodiments, In some embodiments, updating the data validation rule includes processing the rule definition with a large language model.

In some embodiments, the method further includes generating, by the computing device, a user interface for a scope of the data model and the one or more data elements of the data model associated with the scope, wherein the user interface includes a plurality of user interface controls, wherein the user interface is associated with the scope of the data model, and wherein each user interface control of the user interface is associated with a data element of the data model. In some embodiments, the rule definition is indicative of an external document; and generating the user interface includes generating a link to the external document.

In some embodiments, the method further includes presenting, by the computing device, a first user interface associated with a first scope to a user; receiving, by the computing device, a first input value for a first data element of the data model in response to presenting the first user interface to the user; selecting, by the computing device, a first data validation rule of the data model based on the first data element and the first scope; executing, by the computing device, an executable rule logic of the first data validation rule with the first input value in response to selecting the first data validation rule; and determining, by the computing device, whether the executable rule logic successfully validated the input value in response to executing the executable rule logic. In some embodiments, the method further includes storing, by the computing device, the first input value for the first data element of the data model in response to determining that the executable rule logic successfully validated the first input value. In some embodiments, the method further includes providing, by the computing device, an indication of a validation error in response to determining that the executable rule logic did not successfully validate the first input value. In some embodiments, providing the indication of the validation error includes providing a link to a user interface associated with a data element of the data model related to the validation error.

In some embodiments, the method further includes generating, by the computing device, a report based on a report definition indicative of a scope of the data model and one or more data elements of the data model associated with the scope, wherein generating the report includes retrieving data element values for the one or more data elements of the data model.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for efficient, dynamic data modeling and data element validation for program compliance;

FIG. 2 is a simplified block diagram of an environment that may be established by a computing device of the system of FIG. 1; and

FIGS. 3-6 are a simplified flow diagram of at least one embodiment of a method for dynamic data modeling and data element validation for program compliance that may be executed by the computing device of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

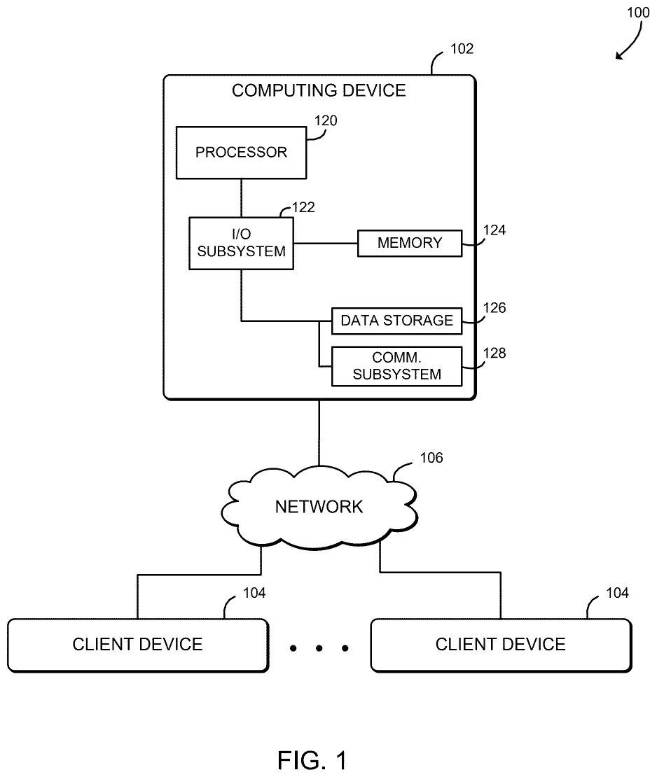

Referring now to FIG. 1, an illustrative system 100 for dynamic data modeling and data element validation for program compliance includes a computing device 102 in communication with one or more client computing devices 104 over a network 106. In use, as described further below, the computing device 102 builds a data model including multiple data elements, data validation rules, and program scopes based on data element definitions and rule definitions, which may be provided by a program administrator or other entity, for example as structured or unstructured data or natural language data. When data element definitions or rule definitions are updated, the computing device 102 may regenerate the data model, modify an existing data model, or otherwise dynamically adapt to the updated definitions. Based on the updated data model, the computing device 102 generates user interfaces for each program or other scope of the data model. For example, the computing device 102 may generate a web application, native application, or other executable interface. Using the client devices 104, users may access the user inputs and provide input data to data model. Using the data model, the computing device 102 validates the input data in real time and allows the users to modify or correct any errors. The computing device 102 may generate reports or otherwise generate data from the user model after performing input validation. Accordingly, the system 100 may provide improved data management, for example to perform program compliance, without requiring custom software applications and while reducing required lead times. Additionally, the system 100 provides real-time validation of input data, which is not possible with existing systems that provide batch processing without data validation. Accordingly, the system 100 may reduce processing time for preparing compliance reports.

The computing device 102 may be embodied as any type of device capable of performing the functions described herein. For example, the computing device 102 may be embodied as, without limitation, a server, a rack-mounted server, a blade server, a workstation, a desktop computer, a laptop computer, a tablet computer, a smartphone, a consumer electronic device, a network appliance, a web appliance, a distributed computing system, a multiprocessor system, and/or any other computing device capable of performing the functions described herein. As shown in FIG. 1, the illustrative computing device 102 includes a processor 120, an I/O subsystem 122, memory 124, a data storage device 126, and communication circuitry 128. Of course, the computing device 102 may include other or additional components, such as those commonly found in a desktop computer (e.g., various input/output devices), in other embodiments. Additionally, in some embodiments, one or more of the illustrative components may be incorporated in, or otherwise form a portion of, another component. For example, the memory 124, or portions thereof, may be incorporated in the processor 120 in some embodiments. Additionally, in some embodiments, the computing device 102 may be embodied as a “virtual server” formed from multiple computing devices distributed across the network 106 and operating in a public or private cloud. Accordingly, although the computing device 102 is illustrated in FIG. 1 as embodied as a single computing device, it should be appreciated that the computing device 102 may be embodied as multiple devices cooperating together to facilitate the functionality described below.

The processor 120 may be embodied as any type of processor or compute engine capable of performing the functions described herein. For example, the processor may be embodied as a single or multi-core processor(s), digital signal processor, microcontroller, or other processor or processing/controlling circuit. Similarly, the memory 124 may be embodied as any type of volatile or non-volatile memory or data storage capable of performing the functions described herein. In operation, the memory 124 may store various data and software used during operation of the computing device 102 such as operating systems, applications, programs, libraries, and drivers. The memory 124 is communicatively coupled to the processor 120 via the I/O subsystem 122, which may be embodied as circuitry and/or components to facilitate input/output operations with the processor 120, the memory 124, and other components of the computing device 102. For example, the I/O subsystem 122 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 122 may form a portion of a system-on-a-chip (SoC) and be incorporated, along with the processor 120, the memory 124, and other components of the computing device 102, on a single integrated circuit chip.

The data storage device 126 may be embodied as any type of device or devices configured for short-term or long-term storage of data such as, for example, memory devices and circuits, memory cards, hard disk drives, solid-state drives, or other data storage devices. The communication circuitry 128 of the computing device 102 may be embodied as any communication circuit, device, or collection thereof, capable of enabling communications between the computing device 102, the client devices 104, and/or other remote devices. The communication circuitry 128 may be configured to use any one or more communication technology (e.g., wireless or wired communications) and associated protocols (e.g., Ethernet, Bluetooth®, Wi-Fi®, WiMAX, etc.) to effect such communication.

Similarly, each of the client devices 104 may be embodied as any type of computation or computer device capable of performing the functions described herein, including, without limitation, a desktop computer, a laptop computer, a notebook computer, a tablet computer, a mobile computing device, a wearable computing device, a server, a rack-mounted server, a blade server, a network appliance, a web appliance, a distributed computing system, a multiprocessor system, a processor-based system, and/or a consumer electronic device. Thus, each client device 104 includes components and devices commonly found in a personal computer or similar computing device, such as a processor, an I/O subsystem, a memory, a data storage device, and/or communication circuitry. Those individual components of the client device 104 may be similar to the corresponding components of the computing device 102, the description of which is applicable to the corresponding components of the client device 104 and is not repeated herein so as not to obscure the present disclosure.

As discussed in more detail below, the computing device 102 and the client devices 104 may be configured to transmit and receive data with each other and/or other devices of the system 100 over the network 106. The network 106 may be embodied as any number of various wired and/or wireless networks. For example, the network 106 may be embodied as, or otherwise include, a wired or wireless local area network (LAN), a wired or wireless wide area network (WAN), and/or a publicly-accessible, global network such as the Internet. As such, the network 106 may include any number of additional devices, such as additional computers, routers, and switches, to facilitate communications among the devices of the system 100.

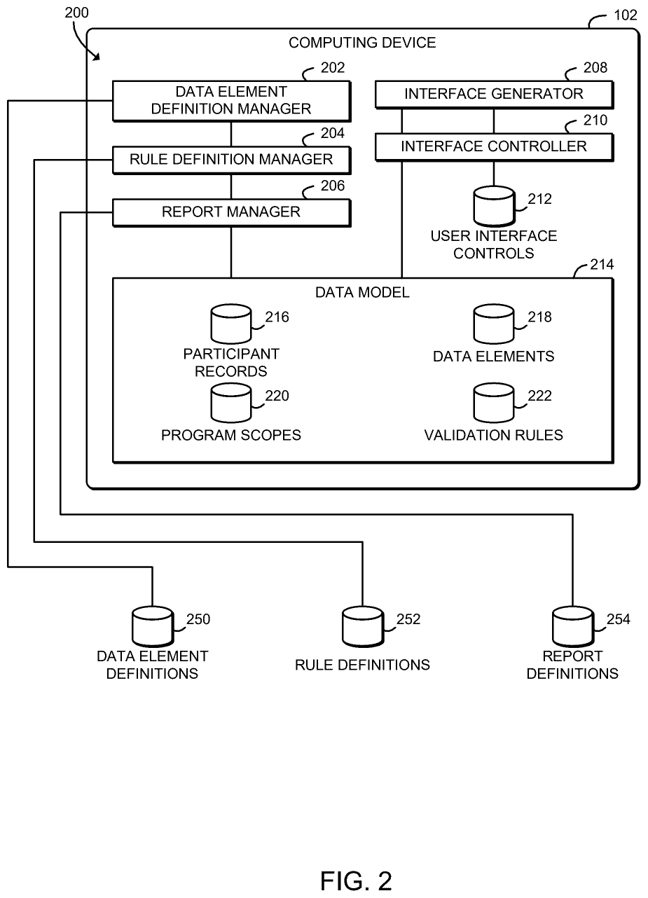

Referring now to FIG. 2, in the illustrative embodiment, the computing device 102 establishes an environment 200 during operation. The illustrative environment 200 includes a data element definition manager 202, a rule definition manager 204, a report manager 206, an interface generator 208, an interface controller 210, and a data model 214. The various components of the environment 200 may be embodied as hardware, firmware, software, or a combination thereof. As such, in some embodiments, one or more of the components of the environment 200 may be embodied as circuitry or a collection of electrical devices (e.g., data element definition manager circuitry 202, rule definition manager circuitry 204, report manager circuitry 206, interface generator circuitry 208, interface controller circuitry 210, and/or data model circuitry 214). It should be appreciated that, in such embodiments, one or more of those components may form a portion of the processor 120, the I/O subsystem 122, and/or other components of the computing device 102.

The data model 214 comprises multiple data elements 218 and multiple scopes 220. Each data element 218 includes attributes, parameters, or other fields such as a data element identifier, a data element type, and a data element format. Each scope 220 is associated with a program for which the computing device 102 manages reporting, such as one or more programs administered by the U.S. Department of Labor under the Workforce Innovation and Opportunity Act (WIOA) or other programs. Each data element 218 is associated with one or more scopes 220 of the data model. As shown, the data model 214 also includes multiple participant records 216. Each participant record 216 may be associated with a particular individual participant in a program of the scopes 220. Each participant record 216 may be associated with part or all of the data elements 218. Data values (e.g., individual rows, records, or other data items) may be stored for each of the data elements 218 using the data model 214. The data model 214 further includes data validation rules 222, which are each associated with one or more of the scopes 220, and which may enforce certain executable rule logic for one or more data elements 218. Accordingly, each of the scopes 220 may be associated with a subset of the data elements 218 in the data model 214 and/or a subset of the data validation rules 222 in the data model 214. The data model 214 may be embodied as one or more databases, relational databases, object-relational data stores, data tables, file systems, or other data stores that may be maintained and/or accessible to the computing device 102. For example, in an embodiment, each of the participant records 216, the data elements 218, the scopes 220, and/or the data validation rules 222 may be embodied as tables of a relational database. Of course, in other embodiments different arrangements and/or configurations of the data model 214 may be used.

The data element definition manager 202 is configured to update a data element 218 of the data model 214 based on a data element definition 250 indicative of a data element identifier, a data element type, a data element format, and one or more scopes. The data element definition 250 may include structured or unstructured data indicative of the data element identifier, the data element type, the data element format, and the one or more scopes. In some embodiments, updating the data element 218 may include parsing the data element definition 250. In some embodiments, the data element definition 250 further includes a natural language description of the data element, and updating the data element may include processing the data element definition 250 with a large language model. The data element definition 250 may be provided by a third party, such as a program administrator or other entity that prescribes reporting requirements for the computing device 102.

The rule definition manager 204 is configured to update a data validation rule 222 of the data model 214 based on a rule definition 252 indicative of one or more data elements 218 of the data model 214, rule logic, and one or more scopes 220 of the data model 214. The executable rule logic of the data validation rule 222 corresponds to the rule logic of the rule definition 252. In some embodiments, the executable rule logic may include an input validation rule that determines whether a data element type or data element format is valid for the corresponding data elements 218 of the data model 214. In some embodiments, the executable rule logic may include a mandatory value rule that determines whether a data element value is stored for the corresponding data elements 218 of the data model 214. In some embodiments, the executable rule logic may include a Boolean function of the corresponding data elements 218. The rule definition 252 may include structured or unstructured data indicative of the one or more data elements 218, the rule logic, and the one or more scopes 220. In some embodiments, updating the data validation rule 222 may include parsing the rule definition 252. In some embodiments, the rule definition 252 may further include a natural language description of the rule logic, and updating the data validation rule 222 may include processing the rule definition 252 with a large language model. Similar to the data element definition 250, the rule definition 252 may be provided by a third party, such as a program administrator or other entity that prescribes reporting requirements for the computing device 102.

The report manager 206 is configured to generate a report based on a report definition 254 indicative of a scope 220 of the data model 214 and one or more data elements 218 of the data model 214 associated with that scope 220. Generating the report may include retrieving data element values for the one or more data elements 218 of the data model 214 that are associated with the report. Similar to the data element definition 250 and/or the rule definition 252, the report definition 254 may be provided by a third party, such as a program administrator or other entity that prescribes reporting requirements for the computing device 102.

The interface generator 208 is configured to generate a user interface for a scope 220 of the data model 214 and the one or more data elements 218 of the data model 214 associated with that scope 220. The user interface may include multiple user interface controls 212. The user interface is associated with the scope 220 of the data model 214, and each user interface control 212 of the user interface is associated with a data element 218 of the data model 214. In some embodiments, the rule definition 254 may be indicative of an external document; and generating the user interface may include generating a link to the external document.

The interface controller 210 is configured to present a user interface associated with a particular scope 220 to a user and to receive an input value for a data element 218 of the data model 214 in response presenting that user interface to the user. The interface controller 210 is further configured to select a data validation rule 222 of the data model 214 based on that data element 218 and scope 220 and to execute an executable rule logic of that data validation rule 222 with the input value received from the user. The interface controller 210 is further configured to determine whether the executable rule logic successfully validated the input value, and, if successfully validated, to store the supplied input value for the corresponding data element 218 of the data model 214. The interface controller 210 may be further configured to provide an indication of a validation error if the executable rule logic did not successfully validate the supplied input value. The indication of the validation error may include a link to a user interface associated with a data element 218 of the data model 214 related to the validation error.

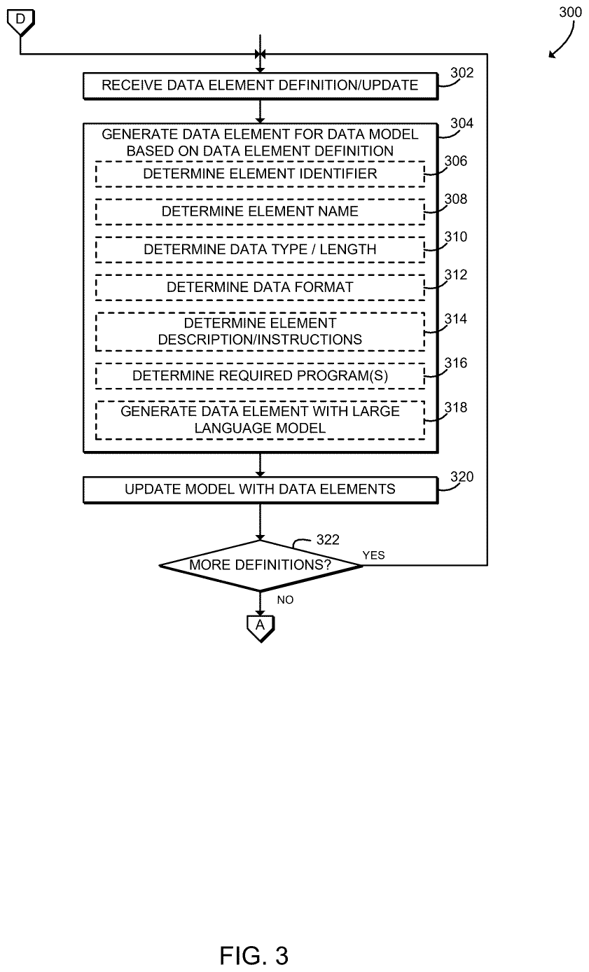

Referring now to FIGS. 3-6, in use, a computing device 102 may execute a method 300 for dynamic data modeling and data element validation. It should be appreciated that, in some embodiments, the operations of the method 300 may be performed by one or more components of the environment 200 of the computing device 102 as shown in FIG. 2. The method 300 begins with block 302, in which the computing device 102 receives a data element definition 250 and/or an update to a data element definition 250. Updated data element definitions 250 may be generated time to time by a program administrator or other entity that prescribes reporting requirements for the computing device 102. The data element definition 250 may include structured and/or unstructured data describing a data element 218 of the data model 214. The data element definition 250 may, for example, include data describing a numeric identifier or other identifier of the data element, an element name, an element data type or length, an element data format, and/or an element description. The data element definition 250 may identify one or more required programs or scopes for the data element 218. As described above, the data element definition 250 may be embodied as structured or unstructured data. For example, in an embodiment, the data element definition 250 may be embodied as a spreadsheet, text file, or other flat file including numeric and/or textual data describing the data element 218.

In block 304, the computing device 102 generates a data element 218 for the data model 214 based on the data element definition 250. The data element 218 may be embodied as a data structure, data record, object, attribute, or other item that represents a particular unit of data to be stored by the data model 214. As described further below, data values may be received and validated for each of the data elements 218, and those validated data values may be stored in relation to the data elements 218, for example in a database, object relational data store, file system, or other data storage system. Also as further described below, the data model 214 may include multiple different data elements 218, and each of the participant records 216 may include or otherwise be associated with data values that are stored in relation to some or all of the data elements 218.

The computing device 102 may use any appropriate technique to generate the data element 218 based on the data element definition 250. For example, the computing device 102 may extract certain data from one or more columns of structured data of the data element definition 250. As another example, the computing device 102 may parse textual or coded data of the data element definition 250. As yet another example, the computing device 102 may process natural language data of the data element definition 250 using one or more natural language processing, machine learning, and/or artificial intelligence techniques. In some embodiments, in block 306 the computing device 102 may determine an element identifier for the data element definition 218. The element identifier may be embodied as a numeric identifier or other identifier of the data element 218. This element identifier may be a globally unique identifier or may be unique for the particular data model 214. For example, in some embodiments, the data element identifier may be a participant individual record layout (PIRL) data element number. In some embodiments, in block 308 the computing device 102 may determine an element name, which may be embodied as a string or other alphanumeric value. In some embodiments, in block 310 the computing device 102 may determine an element data type or length. For example, the data element type may be an integer number, an alphanumeric value, a date, or other data type, and may have a certain length measured in characters or other symbols. In some embodiments, in block 312 the computing device 102 may determine an element data format. The element data format may indicate one or more patterns for valid data including, for example, the number and/or position of numeric characters, alphanumeric characters, date or time values, particular letters, numbers, or punctuation, enumerations of valid data values, and/or other features of valid data values for the data element 218. The data format may be embodied as, for example, a coded string, a regular expression, or other format definition. In some embodiments, in block 314 the computing device 102 may determine an element description or validity instructions from the data element definition 250. The element description may be embodied as a string or other natural language data describing the semantic meaning of the data element 218 and/or describing data validity requirements of the data element 218. In some embodiments, in block 316 the data element definition 250 may identify one or more required programs or scopes 220 for the data element 218. Each data element 218 may be required for one or more of the different programs administered by the entity that requires reporting by the computing device 102. For example, the Department of Labor administers several programs under the Workforce Innovation and Opportunity Act (WIOA), and each of those programs may have a different set of required data elements 218. Accordingly, the required data elements 218 for each program may be included in or otherwise related to a corresponding scope 220 of the data model 214. The data element definition 250 may include a bitmap, a set of columns, or other data indicating the required programs for the data element 218. The computing device 102 may parse that data element definition 250 and assign the data element 218 to the appropriate one or more scopes 220 of the data model 214. The particular programs or scopes 220 of the data model 214 may be predetermined and/or may be updated from time to time.

In some embodiments, in block 318 the computing device 102 may generate the data element 218 using a large language model. For example, the computing device 102 may provide a prompt including the data element name, data element description, and/or other data from the data element definition 250 to a large language model, and the large language model may determine appropriate attributes of the data element 218. The large language model may, for example, output computer executable code (e.g., Python, Javascript, JSON, or other code) that defines the data element 218. Additionally or alternatively, in some embodiments the large language model may call one or more tools that define the data element 218. The large language model may be embodied as a fine-tuned model or a custom-trained model, for example a model that has been trained using example data element definitions 250. The large language model may be hosted by the computing device 102 and/or may be hosted by one or more cloud servers or other remote hosts.

In block 320, the computing device 102 updates the data model 214 with the generated data element 218. In some embodiments, the computing device 102 may build a new data model 214 by adding the newly generated data elements 218. Additionally or alternatively, in some embodiments, the computing device 102 may update an existing data model 214, for example by modifying or replacing existing data elements 218. In some embodiments, the computing device 102 may maintain previous versions of data elements 218, for example to allow historical reporting and recordkeeping.

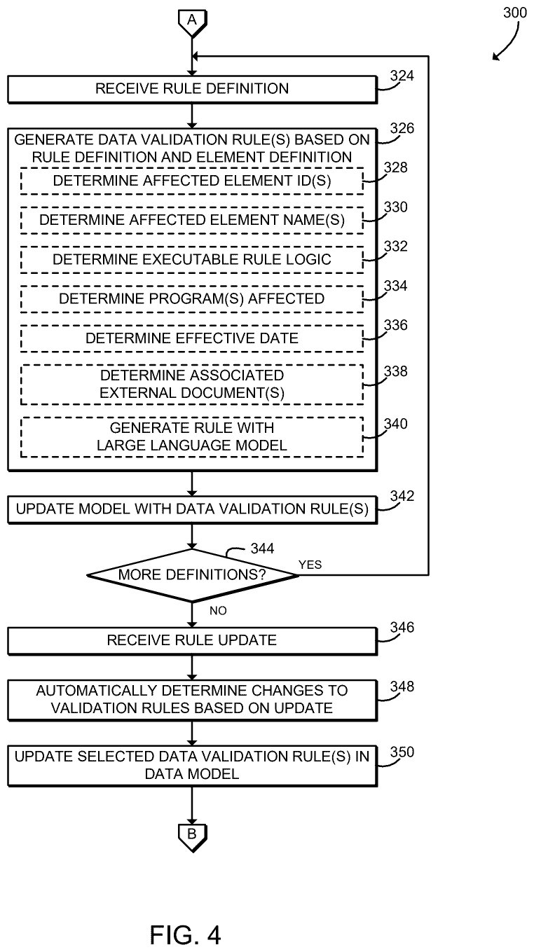

In block 322, the computing device 102 determines whether additional data element definitions 250 remain. For example, in an embodiment, the computing device 102 may determine whether additional rows or other data records exist in a spreadsheet or other data file describing the data element definitions. If additional data element definitions 250 remain, the method 300 loops back to block 302 to continue processing data element definitions 250. If no additional data element definitions 250 remain, the method 300 advances to block 324, shown in FIG. 4.

In block 324, shown in FIG. 4, the computing device 102 receives a rule definition 252. Similar to the data element definition 250, the rule definition 252 may include structured and/or unstructured data describing a data validation rule 222 of the data model 214. The rule definition 252 may, for example, include data describing one or more affected data elements 218 (e.g., data element identifier, data element name or other identifier), data describing one or more logical requirements of the rule, data describing programs effected, and/or an implementation data of the rule. As described above, the rule definition 252 may be embodied as structured or unstructured data. For example, in an embodiment, the rule definition 252 may be embodied as a spreadsheet, text file, or other flat file including numeric and/or textual data describing the data validation rules 222.

In block 326, the computing device 102 generates a data validation rule 222 for the data model 214 based on the rule definition 252 and/or one or more data element definitions 250. As described further below, the data validation rule 222 may include one or more logical tests or other executable rule logic that may be evaluated to determine whether a data value is valid for one or more data elements 218 of the data model 214. The computing device 102 may use any appropriate technique to generate the data validation rule 222 based on the rule definition 252. For example, the computing device 102 may extract certain data from one or more columns of structured data of the rule definition 252. As another example, the computing device 102 may parse textual or coded data of the rule definition 252. As yet another example, the computing device 102 may process natural language data of the rule definition 252 using one or more natural language processing, machine learning, and/or artificial intelligence techniques. In some embodiments, in block 328 the computing device 102 may determine a data element identifier for the data validation rule 222. The element identifier may be embodied as a numeric identifier or other identifier of one or more of the data elements 218. As described above, those element identifiers are globally or otherwise unique for the data model 214, and thus may be used to identify particular data elements 218. In some embodiments, in block 330 the computing device 102 may determine one or more affected element names. The computing device 102 may verify that the element name(s) supplied in the rule definition 252 match the element name of the identified data element 218 (which was defined by the data element definition 250).

In some embodiments, in block 332 the computing device 102 may determine executable rule logic for the data validation rule 222. The executable rule logic may be embodied as one or more functions (e.g., Boolean functions), scripts, or other blocks of executable computer code that may be executed to determine whether the data validation rule 222 has been satisfied. The computing device 102 may parse, compile, analyze, or otherwise process a textual description of the rule logic from the rule definition 252 in order to generate the executable rule logic for the data validation rule 222. In some embodiments, the data validation rule 222 may be embodied as a mandatory value rule, in which the executable rule logic determines whether any value has been supplied for the data element 218. In some embodiments, the data validation rule 222 may be embodied as a data format rule, in which the executable rule logic determines whether a supplied data value satisfies a data type and/or data format specified for the data element 218. In some embodiments, the data validation rule 222 may be embodied as a logic rule, in which the executed rule logic may determine whether a given logical expression, which may be in terms of one or more data elements 218, constant values, or other values, is true or false.

In some embodiments, in block 334 the computing device 102 may determine one or more programs 220 affected by the data validation rule 222. The rule definition 252 may include a coded string, a bitmap, a set of columns, or other data indicating the required programs 220 for the data validation rule 222. The computing device 102 may parse that rule definition 252 and assign the data validation rule 222 to the appropriate one or more scopes 220 of the data model 214. As described above, the particular programs or scopes 220 of the data model 214 may be predetermined and/or may be updated from time to time. In some embodiments, in block 336 the computing device 102 may determine an effective date for the data validation rule 222. The effective date may be represented in the rule definition 252 as a string-based date representation or other representation of a date. In some embodiments, in block 338 the computing device 102 may determine one or more external documents associated with the data rule 222. The external documents may include rule explanations, sources, documentation, or other data associated with the data validation rule 222, and the external documents may be identified by URL or other external document identifier.

In some embodiments, in block 340 the computing device 102 may generate the data validation rule 222 using a large language model. For example, the computing device 102 may provide a prompt including the natural language description of the rule logic from the rule definition 252 to a large language model, and the large language model may determine one or more appropriate attributes of the data validation rule 222. The large language model may, for example, output the executable rule logic as computer executable code (e.g., Python, Javascript, JSON, or other code). Additionally or alternatively, in some embodiments the large language model may call one or more tools that define the data validation rule 222. The large language model may be embodied as a fine-tuned model or a custom-trained model, for example a model that has been trained using example rule definitions 252. The large language model may be hosted by the computing device 102 and/or may be hosted by one or more cloud servers or other remote hosts.

In block 342, the computing device 102 updates the data model 214 with the generated data validation rules 222. In some embodiments, the computing device 102 may build a new data model 214 by adding the newly generated data validation rules 222. Additionally or alternatively, in some embodiments, the computing device 102 may update an existing data model 214, for example by modifying or replacing existing data validation rules 222. In some embodiments, the computing device 102 may maintain previous versions of data validation rules 222, for example to allow historical reporting and recordkeeping.

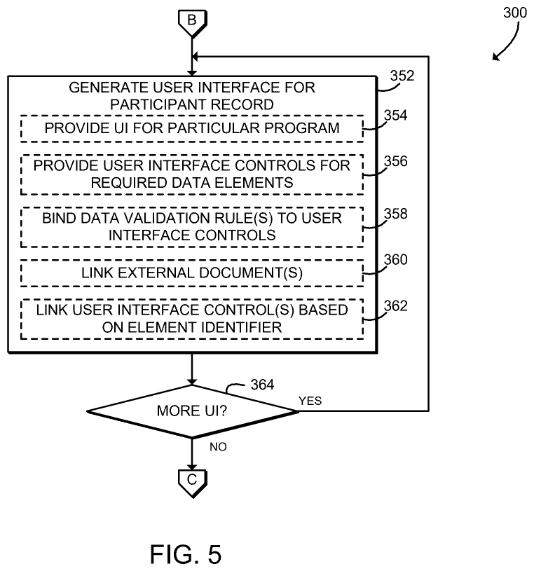

In block 344, the computing device 102 determines whether additional data rule definitions 252 remain. For example, in an embodiment, the computing device 102 may determine whether additional rows or other data records exist in a spreadsheet or other data file describing the data element definitions. If additional data rule definitions 252 remain, the method 300 loops back to block 324 to continue processing data rule definitions 252. If no additional data rule definitions 252 remain, the method 300 advances to block 346, shown in FIG. 5.

In block 346, the computing device 102 may receive one or more updates to the validation rules. Updated rule definitions 252 may be generated time to time by a program administrator or other entity that prescribes reporting requirements for the computing device 102. The updated validation rules received by the computing device 102 may be embodied as structured or unstructured data similar to an original rule definition 252. Additionally or alternatively, the rule update may be embodied as a natural language or other description of changes to existing validation rules.

In block 348, the computing device 102 automatically determines changes to one or more data validation rules 222 based on the received rule update. The computing device 102 may, for example, compare an updated rule definition 252 to one or more existing data validation rules 222 and determine changes to the existing rules, such as changed mandatory values, changed data formats, changed executable rule logic, and/or other changes to the data validation rules. The computing device 102 may determine the changes to data validation rules by, for example, parsing, compiling, analyzing, or otherwise processing a textual description of the rule update. In some embodiments, the rule update may be processed using a large language model, as described above.

In block 350, the computing device 102 updates the data model 214 with the updated data validation rules 222. For example, in some embodiments, the computing device 102 may update an existing data model 214 by modifying or replacing existing data validation rules 222. In some embodiments, the computing device 102 may maintain previous versions of data validation rules 222, for example to allow historical reporting and recordkeeping. The computing device 102 may retain existing data validation rules 222 that were not modified by the rule update. After updating the data model 214 as appropriate, the method 300 advances to block 352, shown in FIG. 5.

In block 352, shown in FIG. 5, the computing device 102 generates a user interface for a participant record 216, including one or more data elements 218. The computing device 102 may, for example, generate a declarative user interface definition which may be compiled, interpreted, or otherwise executed by a user interface of the computing device 102 and/or one or more client devices 104. The computing device 102 may use any appropriate user interface technology to generate the user interface. For example, the computing device 102 may generate a web application or other remote interface, a native application interface, a programmatic interface (e.g., API), or any other interface that allows reading and/or writing the appropriate data elements 218. In some embodiments, in block 354 the computing device 102 may generate the user interface for a particular program scope 220. For example, the computing device 102 may generate a user interface to provide read and/or write access to the data elements 218 of the data model 214 that are associate with a particular scope 220 of the data model 214. As described further below, that scope 220 may correspond to the particular program associated with a report definition 254. In some embodiments, in block 356 the computing device 102 may provide one or more user interface controls 212 for the required data elements 218, for example the data elements 218 for a participant record 216, which may be associated with a particular scope 220. The user interface controls 212 may be embodied as, for example, text boxes, date pickers, numeric entry fields, radio buttons, combo boxes, or other user interface elements provided by a web environment, a native application environment, or other user interface paradigm of the computing device 102 and/or the client devices 104. Each particular user interface control 212 may be selected and/or customized based on the data type and/or the data format of the associated data element 218. In some embodiment, the user interface control may be a composite control formed from one or more sub-controls or otherwise composed from other controls. In some embodiments, in block 358 the computing device 102 may bind one or more validation rules 222 to the associated user interface controls 218. For example, the computing device 102 may use one or more event handling systems, form validation systems, or other systems to link data validation rules 222 to the user interface controls 212 for the associated data elements 218. As described further below, when a user provides input data with the user interface control, the executable rule logic of the validation rule 222 may be executed in order to validate the provided input data. In some embodiments, in block 360 the computing device 102 may link one or more external documents to the user interface. For example, the computing device 102 may provide a hyperlink or other external link to the external documents in connection with an associated user input control 212. In some embodiments, in block 362 the computing device 102 may link one or more user input control(s) 212 based on data element identifier. For example, in an embodiment, each user interface control 212 or collection of user interface controls 212 may have a specific identifier, such as a URL or other web address. Continuing that example, the address of each user interface control 212 may be determined based on a given data element identifier, for example by referencing the data element identifier in the address or through some other predetermined mapping. In that example, hyperlinks to other data element identifiers may be provided in the user interface such that, when the hyperlink is selected by a user, the appropriate user interface controls 212 for that data element identifier are presented to the user. Accordingly, the user interface provided by the computing device 102 may enable navigation between data elements 218.

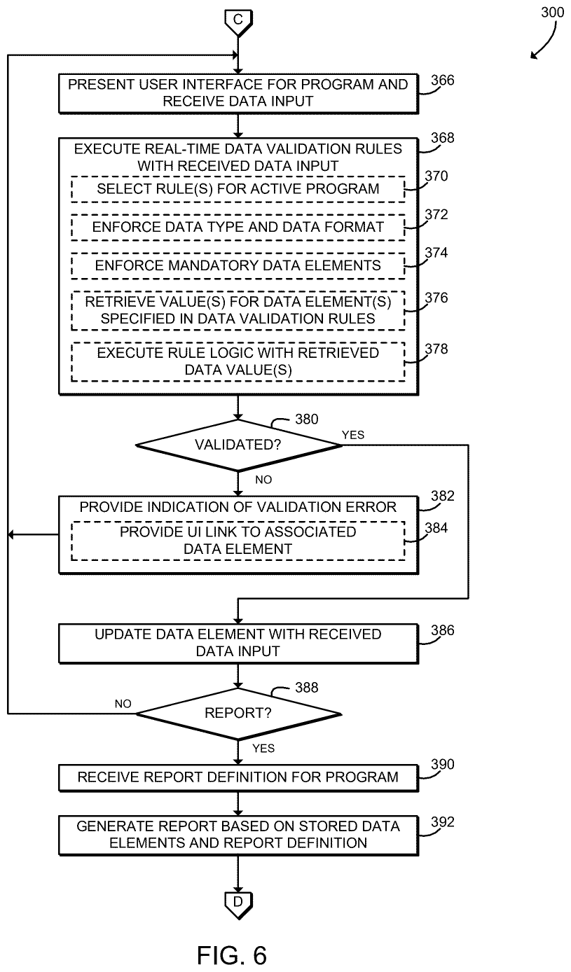

In block 364, the computing device 102 determines whether additional user interface remains to be generated. For example, in an embodiment, the computing device 102 may determine whether additional sheets, screens, tabs, or other user interface elements remain for data elements 218 associated with a participant record 216. As another example, the computing device 102 may determine whether additional programs 220 require generation of associated user interface. If additional user interface remains, the method 300 loops back to block 346 to continue generating the user interface. If no additional user interface remains, the method 300 advances to block 366, shown in FIG. 6.

In block 366, shown in FIG. 6, the computing device 102 presents the user interface for a program 220 and receives data input from a user. As described above, the user interface may be embodied as any user interface that allows a user of the computing device 102 and/or one or more of the client devices 104 to access the data elements 218 of the data model 214. For example, the user interface may include multiple user interface controls 212 associated with the data elements 218 of a program 220. Those data elements 218 may be selected or otherwise associated with a particular individual participant record 216 of the data model 214. The user interface may be embodied as a web application or other remote interface, a native application interface, a programmatic interface (e.g., API), or any other interface that allows reading and/or writing the appropriate data elements 218. In the illustrative embodiment, the computing device 102 may generate, transmit, or otherwise present a web application including one or more web forms or other web pages associated with the program 220. The computing device 102 may receive one or more data input values from the user in response to presenting the user interface.

In block 368, the computing device 102 executes one or more real-time data validation rules 222 with the received data input. The computing device 102 execute data validation rules 222 that are associated with the data element 218 that is being input by the user. The computing device 102 may, for example, execute the executable rule logic associated with the data validation rule 222 and determine an execution result (e.g., success or failure, true or false, etc.). The validation rules 222 may be executed in real time, for example in an interactive user interface session with the user. By executing the validation rules 222 in real time or otherwise executing the validation rules 222 with low latency and relatively short response times, the computing device 102 may allow the user to correct validation errors quickly and otherwise reduce overall data validation time. In some embodiments, in block 370 the computing device 102 may select one or more data validation rules 222 for a currently active program 220, for example the program 220 associated with the current user interface. Accordingly, the computing device 102 may support different validation rules 222 applied to the data elements 218 based on different programs or scopes 220 of the data model 214. In some embodiments, in block 372 the computing device 102 may enforce a data type and/or data format for the data element 218. For example, the executable rule logic may indicate success if the supplied user input value has the correct type specified by the data element 218 (e.g., integer number, alphanumeric value, date, and/or other data type). As another example, the executable rule logic may indicate success if the supplied user input value has the correct length and/or format specified by the data element 218 (e.g., correct number of characters, digits, letters, or other symbols, matches specified pattern of numbers, letters, etc., matches enumerated list of input values, etc.). In some embodiments, in block 374 the computing device 102 may enforce one or more mandatory data elements 218. For example, the executable rule logic may indicate success if a value was supplied for the mandatory data element 218 and indicate failure if no value was supplied for the mandatory data element 218 (e.g., the form field or other user interface control 212 was left blank by the user). In some embodiments, in block 376 the computing device 102 may retrieve any stored data values for data elements 218 specified in the data validation rule 222. For example, in an embodiment the executable rule logic may reference one or more data elements 218. Continuing that example, to evaluate that executable rule logic, the computing device 102 may retrieve one or more stored values for that data element 218 from the data model 214. Those values may have been previously supplied as user input or otherwise previously stored with the data model 214. In some embodiments, the computing device 102 may retrieve data elements 218 for a particular participant record 216 of the data model 214, for a particular program scope 220 of the data model 214, or otherwise select a subset of data values stored for the data elements 218 in the data model 214. In block 378, the computing device 102 executes the executable rule logic with one or more retrieved data values for the associated data elements. For example, the computing device 102 may execute the executable rule logic using a JavaScript interpreter, compiler, or other execution engine of the computing device 102. The computing device 102 may determine whether execution of the executable rule logic indicated success or failure (e.g., returned true or false or otherwise indicated success).

In block 380, the computing device 102 determines whether the data validation rule(s) 222 were successfully validated. If so, the method 300 branches ahead to block 386, described below. If the data validation rules 222 were not successfully validated, the method 300 advances to block 382, in which the computing device 102 provides an indication of the validation error. The computing device 102 may, for example, identify the data element 218 that was not successfully validated, provide an error message or other output from the executable rule logic, or otherwise indicate why validation was not successful. In some embodiments, in block 384 the computing device 102 may provide a user interface link to an associated data element 218. For example, the computing device 102 may provide one or more links to other data elements 218 referenced by the data validation rule 222. As described above, the computing device 102 may provide a specific identifier, such as a URL or other web address for a user interface control 212 associated with the data elements 218. After providing the indication of validation error, the method 300 loops back to block 366, in which the computing device 102 may re-present the user interface and collect additional and/or corrected user input data from the user. Accordingly, the user may be able to correct the user input in real time or in near real time, which may improve usability and accuracy of the data input process.

Referring again to block 380, if the user input was validated, the method 300 advances to block 386, in which the computing device 102 updates the data element 218 with the received data input values. The computing device 102 may store the supplied, validated user input value into the data model 214 for the data element 218 in association with the current participant record 216. Accordingly, the computing device 102 may populate the data model 214 with data values for the data elements 218 associated with each participant record 216 in a particular program scope 220.

In block 388, the computing device 102 determines whether to prepare a report, for example for a current program 220. The computing device 102 may prepare reports periodically, responsively, or otherwise. For example, the computing device 102 may prepare a quarterly report in response to a request from a user. If the computing device 102 determines not to generate a report, the method 300 loops back to block 366, in which the computing device 102 continues to provide the user interface, receive user input data, and validate the input data. If the computing device 102 determines to generate a report, the method 300 advances to block 390.

In block 390, the computing device 102 receives a report definition 254 and/or an update to a report definition 254. Updated report definitions 254 may be generated time to time by a program administrator or other entity that prescribes reporting requirements for the computing device 102. Similar to the data element definition 250 and/or the rule definition 252, the report definition 254 may include structured and/or unstructured data describing a required report, which may be associated with a particular program or scope 220 of the data model 214. The report definition 254 may, for example, include data describing one or more included data elements 218 (e.g., data element identifier, data element name or other identifier) for a particular scope 220. As described above, the report definition 254 may be embodied as structured or unstructured data. For example, in an embodiment, the report definition 254 may be embodied as a spreadsheet, text file, or other flat file including numeric and/or textual data describing one or more data elements 218 included in the report. For example, in some embodiments the report definition 254 may be embodied as a spreadsheet including a column identifying the data elements 218 by their data element identifier.

In block 392, the computing device 102 generates a report based on the stored data elements 218 of the data model 214 and the received report definition 254 associated with a program scope 220. For example, the computing device 102 may select all data elements 218 associated with a particular program scope 220 and retrieve the corresponding data values for those data elements 218. In some embodiments, the retrieved values for the data elements 218 may be associated with corresponding participant records 216, for example by being returned as corresponding rows, query results, or other reporting entries. Additionally or alternatively, some or all of the values for the data elements 218 may be aggregated or otherwise processed for all participants in the program scope 220. The report may be generated in any appropriate electronic reporting format. For example, in an embodiment the report may be formatted as one or more structure data files, spreadsheets, text files, or other electronic data suitable for submission to an electronic reporting portal or endpoint. In an illustrative example, the report may be formatted for submission to a Workforce Integrated Performance System (WIPS) maintained by the U.S. Department of Labor. The computing device 102 and/or a client device 104 may submit the generated report or otherwise process the generated report. After generating the report, the method 300 loops back to block 302, shown in FIG. 3, in which the computing device 102 may update the data model 104 and/or receive additional data input as described above.

Although illustrated and described as being performed sequentially, it should be understood that one or more operations of FIG. 3 may be performed in parallel and/or may be performed out of order or in a different order. For example, in an embodiment the data model 214 may be updated based on updated data element definitions 250, rule definitions 252, and/or report definitions 254 as those are received or entered, and data entry with the existing data model 214 may continue as described.

1. A computing device for real-time data model interaction, the computing device comprising:
a data model comprising a plurality of data elements and a plurality of scopes, wherein each data element comprises a data element identifier, a data element type, and a data element format, and wherein each data element is associated with one or more scopes of the data model; and
a data element definition manager to update a data element of the data model based on a data element definition indicative of a data element identifier, a data element type, a data element format, and one or more scopes.

2. The computing device of claim 1, wherein each of the scopes is associated with a program, and wherein each data element is associated with a program participant.

3. The computing device of claim 1, wherein:
the data element definition comprises structured or unstructured data indicative of the data element identifier, the data element type, the data element format, and the one or more scopes;
the data element definition further comprises a natural language description of the data element; and
to update the data element comprises to process the data element definition with a large language model.

4. The computing device of claim 1, further comprising a rule definition manager, wherein:
the data model further comprises a plurality of data validation rules, wherein each data validation rule comprises an executable rule logic, and wherein each data validation rule is associated with one or more data elements of the data model and one or more scopes of the data model; and
the rule definition manager is to update a data validation rule of the data model based on a rule definition indicative of one or more data elements of the data model; rule logic, and one or more scopes of the data model, wherein the executable rule logic of the data validation rule corresponds to the rule logic of the rule definition.

5. The computing device of claim 4, wherein the executable rule logic comprises: (i) an input validation rule that determines whether a data element type or data element format is valid for the corresponding one or more data elements of the data model, (ii) a mandatory value rule that determines whether a data element value is stored for the corresponding one or more data elements of the data model, or (iii) a Boolean function of the one or more data elements.

6. The computing device of claim 4, wherein the rule definition comprises structured or unstructured data indicative of the one or more data elements, the rule logic, and the one or more scopes.

7. The computing device of claim 6, wherein:
the rule definition further comprises a natural language description of the rule logic; and
to update the data validation rule comprises to process the rule definition with a large language model.

8. The computing device of claim 4, further comprising an interface generator to generate a user interface for a scope of the data model and the one or more data elements of the data model associated with the scope, wherein the user interface comprises a plurality of user interface controls, wherein the user interface is associated with the scope of the data model, and wherein each user interface control of the user interface is associated with a data element of the data model.

9. The computing device of claim 8, further comprising an interface controller to:
present a first user interface associated with a first scope to a user;
receive a first input value for a first data element of the data model in response to presentation of the first user interface to the user;
select a first data validation rule of the data model based on the first data element and the first scope;
execute an executable rule logic of the first data validation rule with the first input value in response to selection of the first data validation rule; and
determine whether the executable rule logic successfully validated the input value in response to execution of the executable rule logic.

10. The computing device of claim 9, wherein the interface controller is further to store the first input value for the first data element of the data model in response to a determination that the executable rule logic successfully validated the first input value.

11. The computing device of claim 9, wherein the interface controller is further to provide an indication of a validation error in response to a determination that the executable rule logic did not successfully validate the first input value.

12. The computing device of claim 11, wherein to provide the indication of the validation error comprises to provide a link to a user interface associated with a data element of the data model related to the validation error.

13. The computing device of claim 8, further comprising a report generator to generate a report based on a report definition indicative of a scope of the data model and one or more data elements of the data model associated with the scope, wherein to generate the report comprises to retrieve data element values for the one or more data elements of the data model.

14. A method for real-time data model interaction, the method comprising:
receiving a data element definition indicative of a data element identifier, a data element type, a data element format, and one or more scopes; and
updating, by a computing device, a data element of a data model based on the data element definition, wherein the data element comprises the data element identifier, the data element type, the data element format, and wherein the data element is associated with the one or more scopes of the data model.

15. The method of claim 14, further comprising:
receiving a rule definition indicative of one or more data elements of the data model, rule logic, and one or more scopes of the data model; and
updating, by the computing device, a data validation rule of the data model based on the rule definition, wherein the data validation rule comprises an executable rule logic corresponding to the rule logic of the rule definition, and wherein the data validation rule is associated with the one or more data elements of the data model and the one or more scopes of the data model.

16. The method of claim 15, further comprising generating, by the computing device, a user interface for a scope of the data model and the one or more data elements of the data model associated with the scope, wherein the user interface comprises a plurality of user interface controls, wherein the user interface is associated with the scope of the data model, and wherein each user interface control of the user interface is associated with a data element of the data model.

17. The method of claim 16, further comprising:
presenting, by the computing device, a first user interface associated with a first scope to a user;
receiving, by the computing device, a first input value for a first data element of the data model in response to presenting the first user interface to the user;
selecting, by the computing device, a first data validation rule of the data model based on the first data element and the first scope;
executing, by the computing device, an executable rule logic of the first data validation rule with the first input value in response to selecting the first data validation rule; and
determining, by the computing device, whether the executable rule logic successfully validated the input value in response to executing the executable rule logic.

18. The method of claim 17, further comprising storing, by the computing device, the first input value for the first data element of the data model in response to determining that the executable rule logic successfully validated the first input value.

19. The method of claim 17, further comprising providing, by the computing device, an indication of a validation error in response to determining that the executable rule logic did not successfully validate the first input value.

20. The method of claim 16, further comprising generating, by the computing device, a report based on a report definition indicative of a scope of the data model and one or more data elements of the data model associated with the scope, wherein generating the report comprises retrieving data element values for the one or more data elements of the data model.
